(19) United States
(12) Patent Application Publication
(10) Pub. No.: US 2022/0047443 A1
(43) Pub. Date: Feb. 17, 2022

(54) STANDING LUMBAR BACK DISTRACTOR APPARATUS

(71) Applicant: Arash Yaghoobian, Sherman Oaks, CA (US)

(72) Inventor: Arash Yaghoobian, Sherman Oaks, CA (US)

(21) Appl. No.: 17/401,519

(22) Filed: Aug. 13, 2021

Related U.S. Application Data
(60) Provisional application No. 63/065,096, filed on Aug. 13, 2020.

(51) Int. Cl. A61H 1/02

(52) U.S. Cl. CPC A61H 1/0229; A61H 2201/1628; A61H 2201/501; A61H 2201/1671; A61H 2201/1638

(57) ABSTRACT

Systems, devices, and methods including a standing lumbar back distractor. The standing lumbar back distractor includes: a stand; a shaft comprising a lower end connected to the base and an upper end distal from the lower end; an elbow support mechanism connected to the upper end of the shaft; and a pelvic support mechanism disposed between the elbow support mechanism and the stand.

### CROSS-REFERENCE TO RELATED APPLICATIONS

This application claims priority to and the benefit of U.S. Provisional Patent Application No. 63/065,096, filed Aug. 13, 2020, the contents of which are hereby incorporated by reference herein for all purposes.

### TECHNICAL FIELD

Embodiments relate generally to equipment for stretching, and more particularly to back and/or spinal cord stretching devices.

### BACKGROUND

A notable source of lower back pain is excessive pressure around the spine. The excessive pressure can further result in additional medical problems such as pinched nerves and herniated discs. One way of relieving the excessive spinal pressure is through spinal decompression therapy.

Spinal decompression therapy involves traction to stretch the spinal column and provide negative pressure to the discs. By providing negative pressure, the discs will be able to draw in more nutrients, oxygen, and moisture to assist in the healing process.

### SUMMARY

A standing lumbar back distractor embodiment may include: a base; a shaft comprising a lower end connected to the base and an upper end distal from the lower end; an elbow support mechanism connected to the upper end of the shaft; and a pelvic support mechanism disposed between the elbow support mechanism and the base.

In additional embodiments, the elbow support mechanism may include: a T-bar, the T-bar connected to the upper end of the shaft; and a pair of elbow supports, wherein each elbow support is disposed at a corresponding end of the T-bar. In additional embodiments, each elbow support may include: an upper portion; an end portion; and a curved portion connected between the upper portion and the end portion. In additional embodiments, the upper portion and the curved portion defines a first channel. In additional embodiments, the end portion defines a second channel. In additional embodiments, each elbow support may include: a cushioning mechanism. In additional embodiments, the upper portion may extend past the stand.

In additional embodiments, the elbow supports may be positioned at shoulder-length apart. In additional embodiments, the pelvic support mechanism may further include: a pelvic support; and an arm comprising a lower end connected to the shaft and an upper end attached to the pelvic support. In additional embodiments, the pelvic support may be rotatably attached to the arm. In additional embodiments, the pelvic support may include: a roller element. In additional embodiments, the pelvic support may include: a foam layer.

In additional embodiments, the pelvic support may include: a front face; and a rear face opposite of the front face. In additional embodiments, the front face may have a concave shape. In additional embodiments, the elbow support mechanism may be slidably connected to the upper end of the shaft.

In additional embodiments, the base may have a weighted portion. In additional embodiments, the pelvis support mechanism may be remotely controlled. In additional embodiments, the elbow support mechanism may be remotely controlled. In additional embodiments, the base may include: a scale.

A method embodiment may include: placing one or more elbows in an elbow support mechanism of a standing lumbar back distractor, wherein the elbow support mechanism is connected to an upper end of a shaft, wherein the shaft comprises a lower end and the upper end, wherein the upper end of the shaft is distal from the lower end of the shaft, and wherein the lower end of the shaft is connected to a base; and pressing a pelvis against a pelvic support mechanism of the standing lumbar back distractor, wherein the pelvic support mechanism is disposed between the elbow support mechanism and the base.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 is a right side elevational view of a standing lumbar back distractor with a user shown for reference;

FIG. 2 depicts a perspective view of the standing lumbar back distractor of FIG. 1;

FIG. 3 is a left side elevational view of the standing lumbar back distractor of FIG. 1;

FIG. 4 is a right side elevational view of the standing lumbar back distractor of FIG. 1;

FIG. 5 is a right-side elevational view of the standing lumbar back distractor indicating a geometric arc.

FIG. 6 is a rear elevational view of the standing lumbar back distractor of FIG. 1;

FIG. 7 is a front elevational view of the standing lumbar back distractor of FIG. 1;

FIG. 8 is top plan view of the standing lumbar back distractor of FIG. 1;

FIG. 9 is a bottom plan view of the standing lumbar back distractor of FIG. 1;

FIG. 10 is a high-level block diagram of the standing lumbar back distractor;

FIG. 11 is a flowchart for a method embodiment; and

FIG. 12 illustrates an example top-level functional block diagram of a computing device embodiment.

### DETAILED DESCRIPTION

The long-standing societal issue of lower back pain is treated at a baseline, with a combination of rest, massage, postural exercise, flexibility training, core strengthening and traction. Traction is a form of decompression therapy that relieves pressure on the spine. Traction may be used to treat herniated discs, sciatica, degenerative disc disease, pinched nerves, and many other back conditions.

Traction is most commonly achieved in the ‘hanging’ position with use of an inversion table, which lessens back pain by eliminating the compressive forces to the lower back by lengthening the muscles and decompressing the joints and nerves. The elimination of compressive forces is believed to reduce tension, promote blood flow, and assist in spinal lengthening and realignment. Hanging upside down by the ankles with compression at the lower limb however, is a position poorly tolerated by many people and uninviting at best. Most people who may benefit from traction cannot utilize this technique, as the assumption of this difficult position is not a reasonable option.

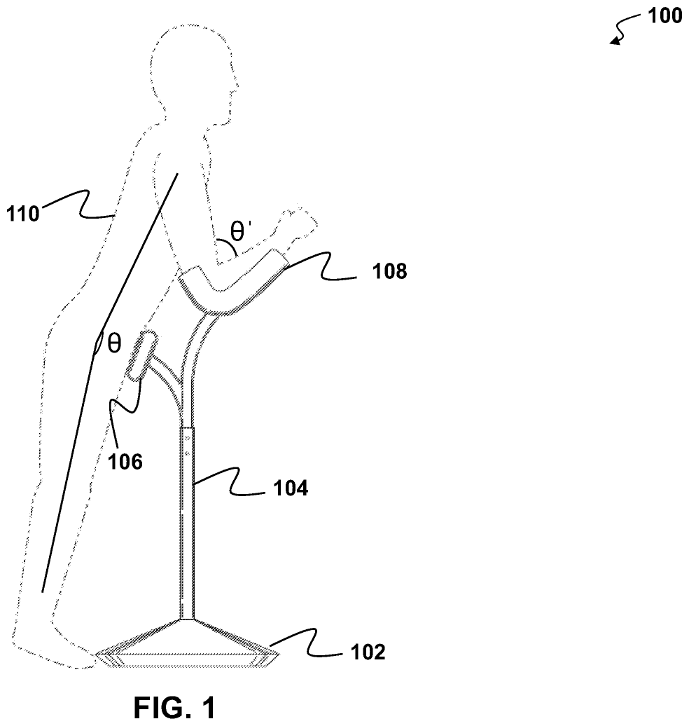

The present system allows for a user to benefit from traction while the user is in a comfortable position. The present system may provide support mechanisms that are positioned to support a user in a substantially upright position. Referring to FIG. 1, in some embodiments, the present system may allow a user to benefit from traction while in a substantially upright position. In some embodiments, the substantially upright position may include a position where a user has their lower body almost perpendicular to the ground and the user has their upper body angularly offset from the lower body. In some embodiments, the angular offset θ between the upper body and the lower body may be minor such as a range between 7° and 45°.

With continued respect to FIG. 1, a standing lumbar back distractor 100 for mitigation of back pain through traction is illustrated. In one embodiment, the standing lumbar back distractor 100 may be self-balancing. In one embodiment, the standing lumbar back distractor 100 may have a weight distribution to provide structural balance. The standing lumbar back distractor 100 allows for the redistribution of force to the abdomen and upper extremities, reducing and/or eliminating compression to the lower back, hips, and lower extremities while supporting the user in a substantially upright position. Traction is achieved in the lumbar spine by maximizing the unabated effects of gravity to the lower extremities. By supporting the user in a substantially upright position, the downsides of a use of an ‘inversion table’ are reduced and/or eliminated, including compression at the ankle or feet and the ill effects of the upside-down position.

Additionally, there is significant ease of use for the standing lumbar back distractor 100. The standing lumbar back distractor 100 may be quickly assembled, such as within a few seconds, for stress relief. The standing lumbar back distractor 100 may be stored, for example, in a corner of a room. The size of the device is notably smaller than that of an inversion table and there is no or minimal preparation for use. In some embodiments, the standing lumbar back distractor 100 may be foldable to have a much smaller size during storage than when in use.

In one embodiment, the standing lumbar back distractor 100 includes a base 102, a shaft 104, a pelvic support mechanism 106, and an elbow support mechanism 108. A user 110 is shown as reference for how one would position oneself on the standing lumbar back distractor 100 to achieve traction in the lumbar spine by maximizing the unabated effects of gravity to the lower extremities. More specifically, the user 110 may slightly lean forward with the user's 110 elbows resting in the elbow support mechanism 108. The user's pelvis may then gently press forward on the pelvic support mechanism 106. In one embodiment, the pelvic support mechanism 106 may be connected the elbow support mechanism 108, and the elbow support mechanism 108 slidably connects to the shaft 104 at an upper end of the shaft. A lower end of the shaft may be inserted into the base 102. In one embodiment, the base 102 does not need to be mechanically fastened to the ground; rather, the shape and size of the base 102 and the standing lumbar back distractor 100 configuration provide for a free-standing, gravity-assisted support to the user 110. In one embodiment, the base 102 may have a weighted portion to balance the standing lumbar back distractor 100.

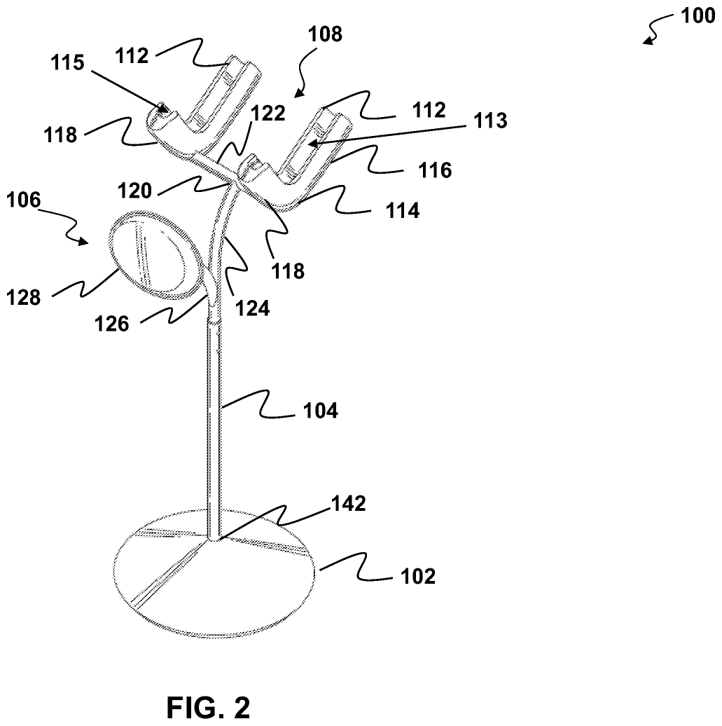

With respect to FIG. 2, a perspective view of the standing lumbar back distractor 100 shows the features of the standing lumbar back distractor 100 in greater detail. Embodiments of the standing lumbar back distractor 100 are described in relation to a local plane where the local plane is parallel to the surface of the earth. In one embodiment, the elbow support mechanism 108 may include a pair of elbow supports 112. Each elbow support 112 may be shaped to accommodate the general shape of a user's middle arm, such as user 110. More specifically, the elbow supports 112 may be hollow with a “j shape”, where the user's 110 elbow seats in a curved portion 114, the forearm seats in an upper portion 116, and the upper arm fits in an end portion 118. In one embodiment, the elbow supports 112 may be made of a rigid, supportive, and durable foam with a leather or leather-like covering. In one embodiment, the durable foam and covering may provide a cushioning mechanism to provide comfort to the user 110 as the user 110 leans into the elbow supports 112. Additionally, the semi-rigidity of the elbow supports 112 may accommodate a large range of arm shapes and sizes. In one embodiment, the elbow supports 112 may be connected to one another with a supporting T-bar 120. The supporting T-bar 120 may have a crossbar 122 that connects the elbow supports 112 to one another. In one embodiment, each end of the crossbar 122 may connect to the curved portion 114 of the elbow support 112. As such, the elbow supports 112 run parallel to each other and are separated by the crossbar 122. In one embodiment, the T-bar 120 may be substantially parallel with the ground to ensure a user 110 leans into the elbow supports 112 in a balanced position. For example, the orientation of the T-bar 120 may ensure the user 110 is in a proper position by forcing the user's 110 shoulder to be substantially aligned with each other while the user 110 is leaning into the elbow supports 112. In one embodiment, the crossbar 122 is connected to the elbow supports 112 with an adhesive. In another embodiment, the crossbar 122 is connected to the elbow supports 112 with fasteners, such as a screw, a nut and bolt, or the like. In another embodiment, the crossbar 122 may be welded or otherwise permanently attached to the elbow supports 112. In one embodiment, the elbow supports 112 are adjustable, such that the elbow supports 112 may be rotated by the user to point with the upper portions 116 more generally pointing towards the ground or away from the ground.

The crossbar 122 of the T-bar 120 may be perpendicular to a stem portion 124. In another embodiment, the crossbar 122 is welded or otherwise permanently attached to the stem portion 124. In one embodiment, the stem portion has a slight curve up and towards the intersection with the crossbar 122. In one embodiment, the slight forward curve guides the standing user 110 standing upright and perpendicular to the local plane to have a slight bend at the waist, thereby forward leaning and resting in to the elbow supports 112, providing traction for the lower back. In one embodiment, the crossbar 122 and the stem 124 are connected with an adhesive. In another embodiment, the crossbar 122 is connected to the stem 124 with fasteners such as screws. In another embodiment, the T-bar 120 with the crossbar 122 and the stem 124 is a single support structure. In one embodiment, the T-bar 120 is made of titanium. In another embodiment, the T-bar 120 is made of steel. In another embodiment, the T-bar 120 is made of a durable, lightweight metal, such as aluminum or carbon fiber, or a combination thereof.

In one embodiment, the elbow supports 112 are approximately shoulder width apart; therefore, the user's 110 elbows neither splay out and away from the user's body nor inward towards the body's midsection. The approximate shoulder width separation provides a more optimum lower back contraction than elbow supports 112 that are positioned wider or narrower to the body. In one embodiment, the elbow supports 112 may be adjustable, such that the elbow supports 112 may be slidable along the crossbar 122. In one embodiment, the crossbar itself 122 may be telescopic to increase and decrease the length of the crossbar 122. In one embodiment, the crossbar 122 and the stem 124 are cylindrical in shape.

Referring back to FIGS. 1-2, in some embodiments, the upper portion 116 and the curved portion 114 may define a first channel 113 and the end portion 118 may define a second channel 115 connected to the first channel 113. The first channel 113 may receive the forearm of a user 110 and the second channel 113 may receive the upper arm of the user 110. The first channel 113 and the second channel 115 may be aligned to provide support for the user's 110 arm while the user 110 is in a substantially upright position and the user's 110 upper arm and the user's 110 forearm have an angular offset θ′ around 90°. In one embodiment, the angular offset θ′ may range between 75° and 105°.

The end portion 118 may be shorter than the upper portion 116 to provide some degree of freedom for the user's 110 upper body. In some embodiments, the upper portion 116 may extend almost the entire length of the user's 110 forearm to provide some degree of freedom to the user's 110 wrists. The user may take advantage of the degree of freedom to perform other exercises such as wrist curls. In one embodiment, the upper portion 116 may extend the entire length of the user's forearm. In some embodiments, the end portion 118 may not extend past the triceps of the user to provide the user some degree of freedom. The configurations of the upper portion 116 and the end portion 118 may provide the user's arms with some degree of freedom while maintaining a substantially upright position. The degree of freedom provided by the upper portion 116 and the end portion 118 provides an advantage by ensuring the user's arm and shoulder muscles are not overly tight while the user is maintaining a substantially upright position.

Attached at the lower end of the stem 124 is an arm 126 of the pelvic support mechanism 106. The arm 126 may curve generally in the opposite direction as the stem 124, and towards the pelvic region of the user 110 (see FIG. 1). In one embodiment, a proximal end of the arm 126 and the stem 124 are connected with an adhesive. In another embodiment, the proximal end of the arm 126 is connected to the stem 124 with fasteners such as screws. In another embodiment, the arm 126 and the T-bar 120 form a single structure. In one embodiment, the arm 126 is made of titanium. In another embodiment, the arm 126 is made of steel. In another embodiment, the arm 126 is made of a durable, lightweight metal, such as aluminum or carbon fiber, or a combination thereof.

The distal end of the arm 126 of the pelvic support mechanism 106 may be attached to a pelvic support 128. In one embodiment, the pelvic support 128 is circular in shape. Other possible pelvic support 128 shapes are possible and contemplated. In one embodiment, the pelvic support 128 has a thickness that may be dependent on the height, weight, and shape of the user. In one embodiment, the pelvic support 128 may rotate with the user, such that as the user leans into the standing lumbar back distractor 100, the pelvic support 128 tilts to match the bending angle of the user. In another embodiment, the pelvic support 128 may have a roller-type element, such that as the user bends forward in the standing lumbar back distractor 100 the pelvic support 128 structure remains static, but the roller element dynamically rotates with the user's forward bending motion. In one embodiment, the pelvic support has a rim 130 around the circumference of the pelvic support 128. In one embodiment, the rim 130 is rounded.

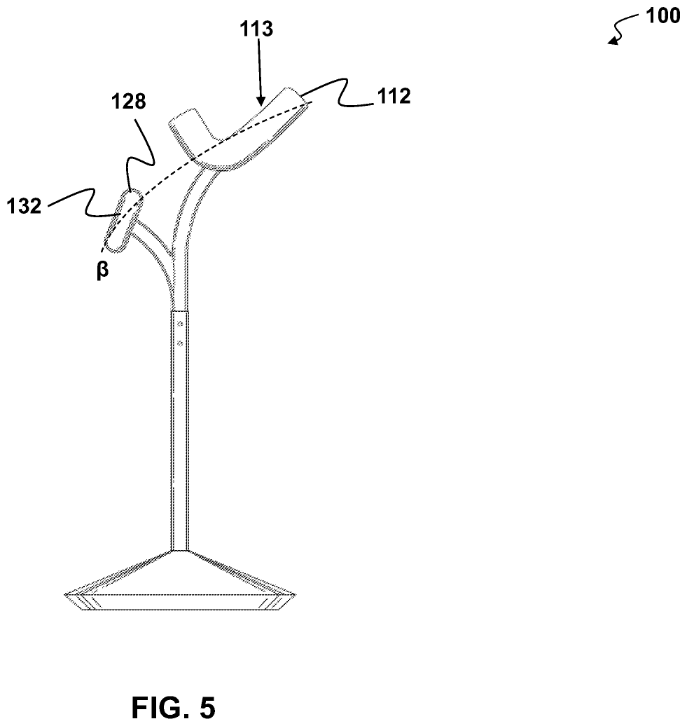

Referring to FIG. 5, in some embodiments, the front face 132 of the pelvic support 128 and the first channel 113 of the elbow supports 112 may be oriented and positioned such that the first channel 113 and the front face 132 form a geometric arc β between both ends of the first channel 113 and both ends of the front face 132. The geometric arc β provides an advantage by allowing the standing lumbar back distractor 100 to simulate a rounded surface for a user lean on and establish a substantially upright position.

In one embodiment, the stem 124 and the arm 126 may be made of substantially rigid materials to prevent the flexing of the arm 126 and stem 124 while the user is in a substantially upright position.

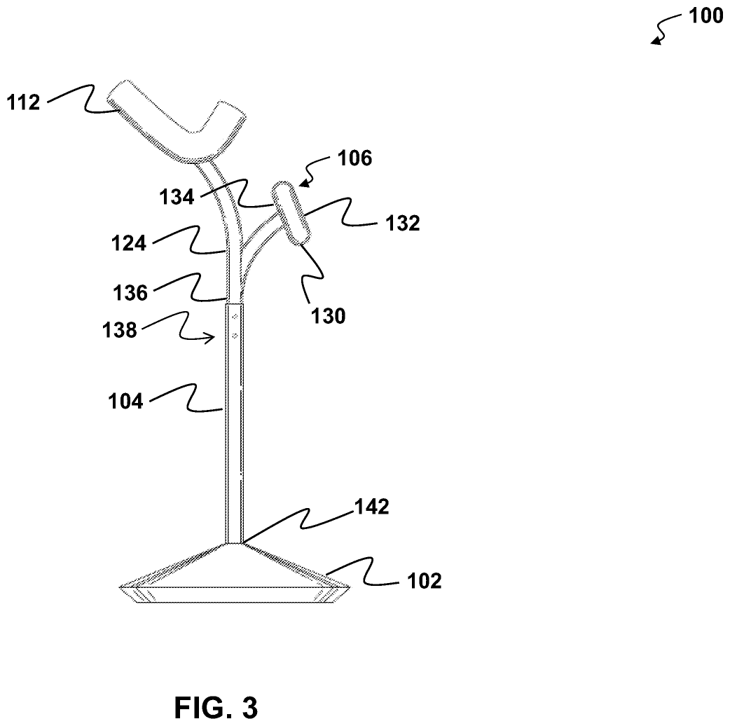

With respect to FIGS. 1-4, the pelvic support 128 may be slightly angled to guide the user 110 to bend at the waist and lean forward into the pelvic support mechanism 106 and the elbow support mechanism 108. In one embodiment, the pelvic support has a front face 132 and a rear face 134 opposite of the front face 132. In one embodiment, the front face 132 may be padded with a soft material, such as foam for comfort as the user 110 leans into the pelvic support mechanism 106. In one embodiment, both the front face 132 and the rear face 134 are concave. In another embodiment, the front face 132 may be concave and the rear face 134 may be flat. In another embodiment, the front face 132 may be flat and the rear face 134 may be concave. In one embodiment, the pelvic support mechanism 106 may be adjustable, such that the arm 126 may be telescopic to increase and decrease the length of the arm 126 to accommodate users of different girths.

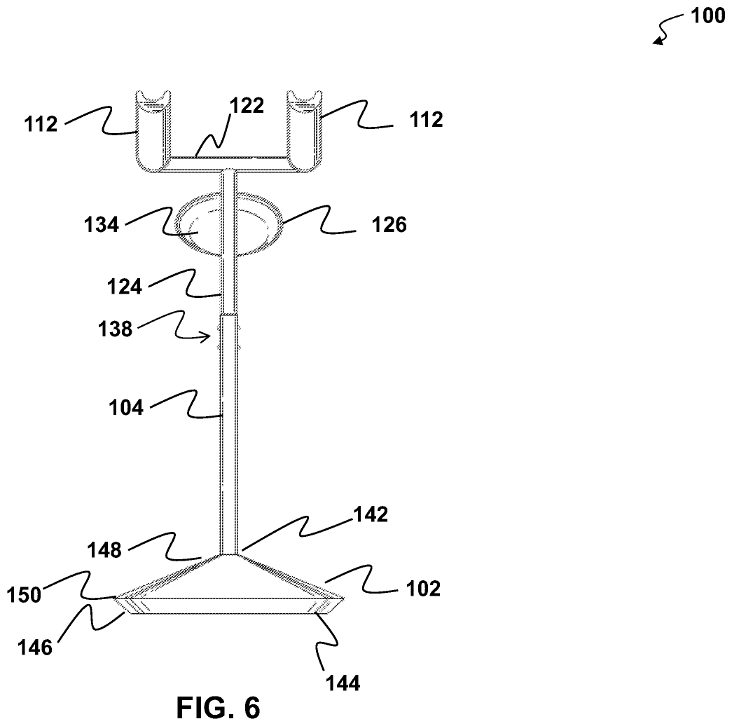

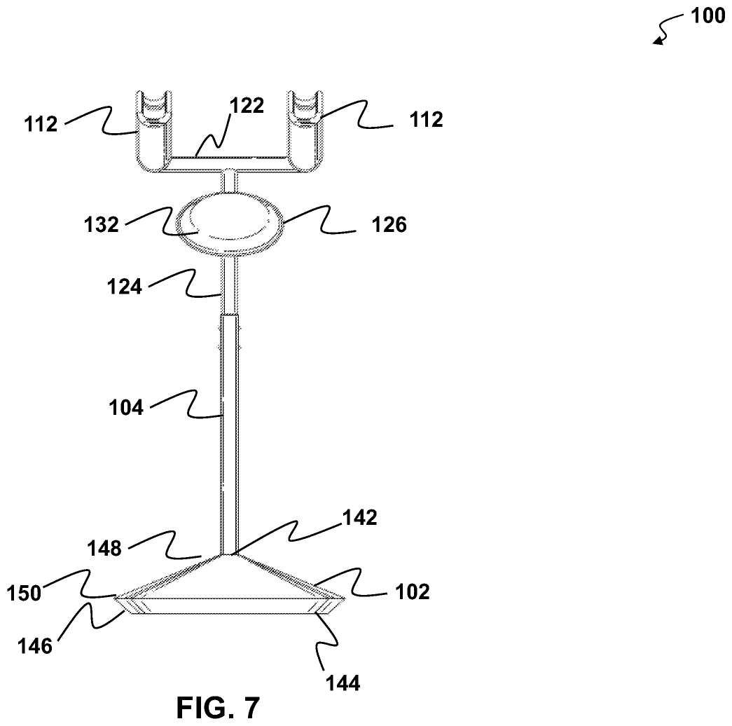

With respect to FIGS. 1-7, the shaft 104 connects to stem 124 of the elbow support mechanism 108. In one embodiment, the shaft 104 is cylindrical in shape with an inner diameter slightly larger than the outer diameter of the stem, thus allowing the stem 124 to slide into an opening 136 at the top end of the shaft 104. In one embodiment, the stem 124 has push buttons 138 to slide into holes of the shaft 104. In one embodiment, the stem 124 has two push buttons. In another embodiment, the stem 124 has four push buttons. In other embodiments, the stem 124 has less than two push buttons, more than two push buttons, or two push buttons. The push button system allows for adjusting of the height of the standing lumbar back distractor 100; specifically, adjust the height of the elbow support mechanism 108 and the pelvic support mechanism 106 to accommodate different heights of users. In one embodiment, the base 102 may be fixed to the ground, such as with screws or bolts. In one embodiment, the shaft 104 attaches directly to the ground, such as by welding or a bracket. For example, the shaft 104 may have a threaded end that threads onto a threaded bracket fastened to the ground. In one embodiment, the base 102 may be weighted to secure the standing lumbar back distractor 100 to the ground when in use. In one embodiment, the height of the standing lumbar back distractor 100 is fixed at a preset height. In one embodiment, the width of the elbow support mechanism 108 is fixed at a preset width. In one embodiment, both the height of the standing lumbar back distractor 100 and the width of the elbow support mechanism 108 are fixed at preset values.

The opposite end of the shaft 104 may be attached to the base 102. In one embodiment, the shaft 104 may slide into an accommodating hole 142 at the center of the base 102, with the shaft oriented perpendicular to the base 102.

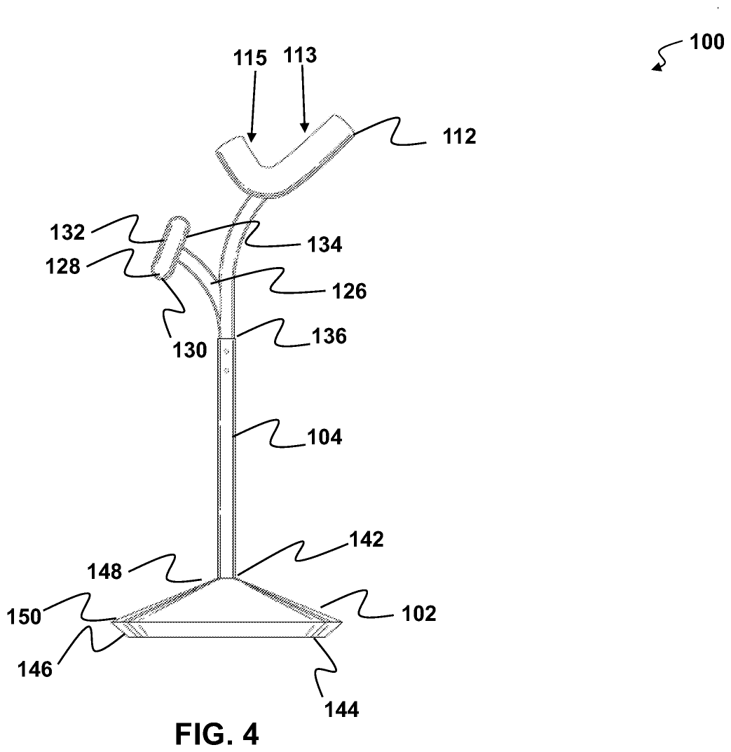

With respect to FIGS. 4-7, the base 102 may include a flat bottom face 144. The base 102 further includes an outwardly tapering bottom section 146 that transitions to an inwardly tapering upper section 148 at a rim 150 of the base 102. In one embodiment, the width of the base 102 may be greater than the width of the elbow support mechanism 108. The width and shape of the base 102 provide stability for the standing lumbar back distractor 100. In one embodiment, the width of the base 102 may be substantially wide enough to provide anti-tilt support but does not impede on the foot/toe space. In one embodiment, the base 102 may be made of a dense, heavy material, such as rubber. In one embodiment, the base 102 may include a foot support component to prevent the user from leaning too far.

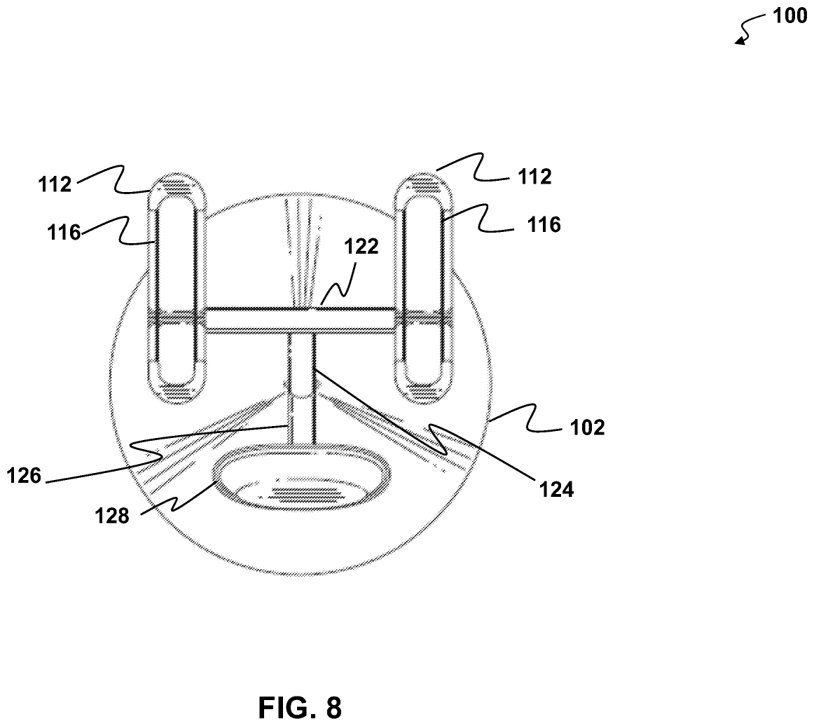

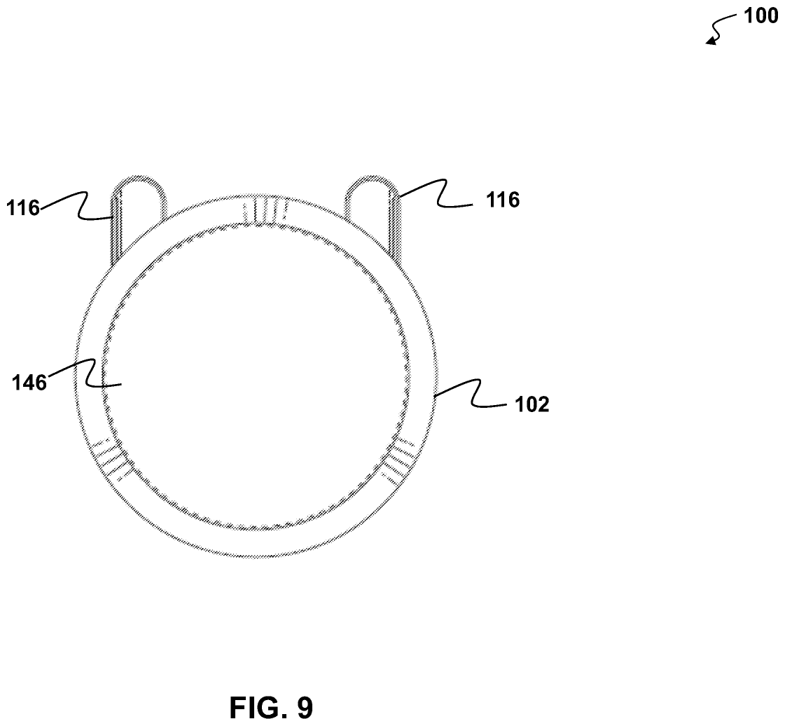

FIGS. 8 and 9 show top and bottom plan views of the standing lumbar back distractor 100, respectively. The upper portions 116 of the elbow supports 112 are forward of the center of the base 102 and generally extend beyond the radius of the base 102, demonstrating how a user would be guided to lean forward and in to the standing lumbar back distractor 100.

Various features of the standing lumbar back distractor 100 may be controlled electronically in some embodiments. In one embodiment, the elbow supports 112 may be adjusted electronically by the user, such as with a computing device 420 described below. In one embodiment, the user may use a remote control or other remote computing device (e.g., tablet, laptop, mobile device, etc.) to control the rotation angle of the elbow supports 112. In another embodiment, the user may select a button located on the standing lumbar back distractor 100 to rotate the elbow supports 112. In one embodiment, the button may be located on the crossbar 122. In another embodiment, a button may be located on each of the elbow supports 112 to control the elbow supports 112 separately. In one embodiment, the button has an up arrow and a down arrow to indicate the direction of rotation of the elbow supports 112. In one embodiment, an interface indicates the angle of rotation of the elbow supports 112.

In one embodiment, the telescopic adjustment of the crossbar 122 may be adjusted electronically by the user, such as with a computing device 420 described below. In one embodiment, the user may use a remote control or other remote computing device (e.g., tablet, laptop, mobile device, etc.) to control the width of the crossbar 122. In another embodiment, the user may select a button located on the standing lumbar back distractor 100 to adjust the width of the crossbar. In one embodiment, the button may be located on the crossbar 122. In another embodiment, the button may be located on the stem portion 124. In one embodiment, the button has an up arrow and a down arrow (or left and right pointing arrows) to indicate a contracting direction or extending direction of the crossbar 122. In one embodiment, an interface indicates the width of the crossbar in certain units, such as inches or centimeters.

In one embodiment, the height of the standing lumbar back distractor 100 may be controlled electronically instead of, or in addition to, push button mechanism 138. In one embodiment, the height of the standing lumbar back distractor 100 may be adjusted electronically by the user, such as with a computing device 420 described below. In one embodiment, the user may use a remote control or other remote computing device (e.g., tablet, laptop, mobile device, etc.) to control the height of the standing lumbar back distractor 100, for example, by the stem portion 124 sliding up or down in the shaft 104. In another embodiment, the user may select a button located on the standing lumbar back distractor 100 to adjust the height of the standing lumbar back distractor 100. In one embodiment, the button may be located on the shaft 104. In another embodiment, the button may be located on the stem portion 124. In another embodiment, the button may be located on the crossbar 122. In one embodiment, the button has an up arrow and a down arrow to indicate a decrease or increase in height of the standing lumbar back distractor 100. In one embodiment, an interface indicates the height of the standing lumbar back distractor 100 in certain units, such as inches or centimeters.

In one embodiment, the pelvic support 128 may be adjusted electronically by the user, such as with a computing device 420 described below. In one embodiment, the user may use a remote control or other remote computing device (e.g., tablet, laptop, mobile device, etc.) to control the rotation angle of the pelvic support 128. In another embodiment, the user may select a button located on the standing lumbar back distractor 100 to rotate the pelvic support 128. In one embodiment, the button may be located on the crossbar 122. In another embodiment, a button may be located on the pelvic support 128. In one embodiment, the button has an up arrow and a down arrow to indicate the direction of rotation of the pelvic support 128. In one embodiment, an interface indicates the angle of rotation of the pelvic support 128.

In one embodiment, sensors may be installed in the base 102. In one embodiment, the sensors may be motion sensors to detect motion of the user's feet. For example, the sensors may detect that the user's feet are off the ground. In another example, the sensors may detect if the user's heels are off the ground and the user's toes are still on the ground. In response to the sensors detecting that the heels of the user are on the ground, the sensors may transmit a signal to the computing device, such as computing device 420, to alert the user to adjust elements of the standing lumbar back distractor 100, such as the rotation of the elbow supports 112 to draw or pull the user's heels off the ground. In one embodiment, a scale attached to the base 102 may detect if the user's feet are off the ground.

In one embodiment, the standing lumbar back distractor 100 may be flexible to allow the user to self-stabilize by leaning into the standing lumbar back distractor 100, and the standing lumbar back distractor 100 flexes with the weight of the user to achieve traction. In one embodiment, the standing lumbar back distractor 100 may have a locking mechanism, such that when the user leans into the standing lumbar back distractor 100, sensors, such as those described above may detect the user has leaned into self-stabilizing position where traction is achieved. Upon detecting the preferred position, the sensors may communicate to the computing device to lock the elements of the standing lumbar back distractor 100 in place, e.g., the rotation of the elbow supports 112, the rotation of the pelvic support 128, the extension of the stem 124 for the shaft 104, and the width of the crossbar 122.

In some embodiments, the standing lumbar back distractor 100 may be mounted to a wall. For example, the elbow support mechanism 108 and the pelvic support mechanism 106 may be fastened to a wall with additional support bars welded to the mechanisms 108, 106.

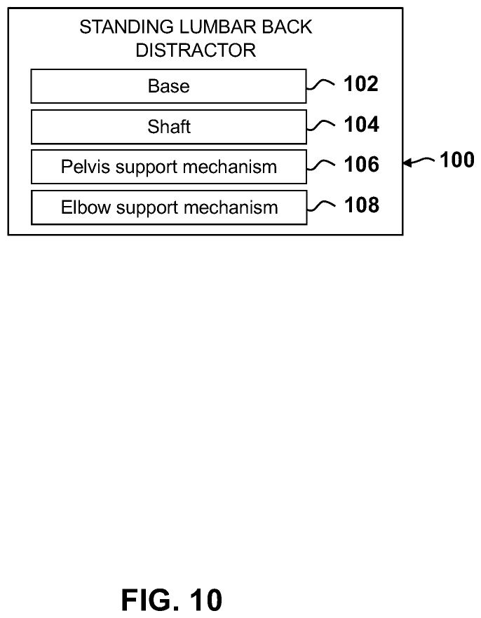

FIG. 10 is a high-level block diagram of the standing lumbar back distractor 100. The standing lumbar back distractor 100 may include a base 102, a shaft 104, a pelvis support mechanism 106 and an elbow support mechanism 108.

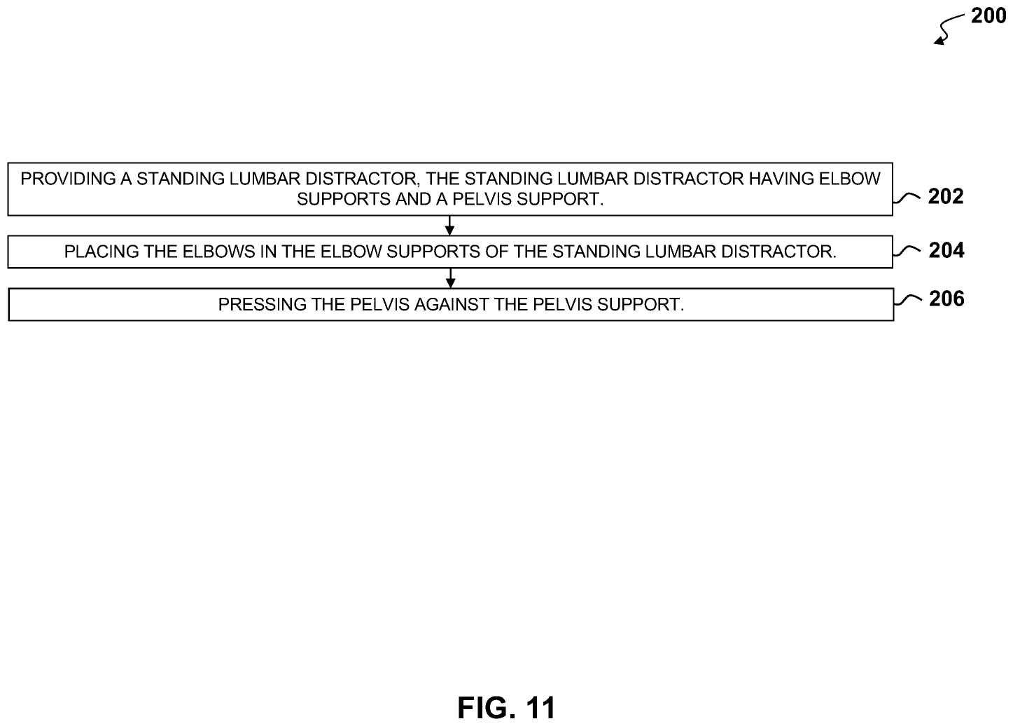

FIG. 11 is a flowchart for a method 200 for providing traction in a substantially upright position. The method 200 may begin with a step 202 for providing a standing lumbar back distractor with elbow supports and a pelvis support. The method may then have a step 204 for placing the elbows in the elbow supports of the standing lumbar back distractor. The method may then have a step 206 for pressing the pelvis against the pelvis support.

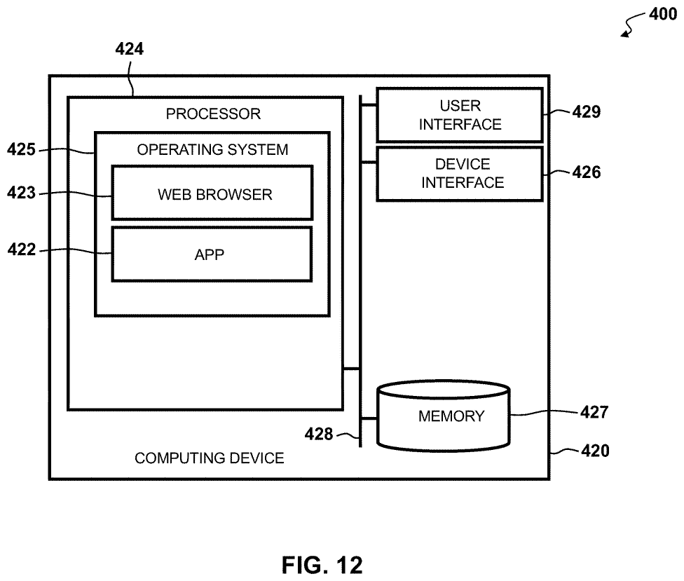

FIG. 12 illustrates an example of a top-level functional block diagram of a computing device embodiment 400. The example operating environment is shown as a computing device 420 comprising a processor 424, such as a central processing unit (CPU), addressable memory 427, an external device interface 426, e.g., an optional universal serial bus port and related processing, and/or an Ethernet port and related processing, and an optional user interface 429, e.g., an array of status lights and one or more toggle switches, and/or a display, and/or a keyboard and/or a pointer-mouse system and/or a touch screen. Optionally, the addressable memory may include any type of computer-readable media that can store data accessible by the computing device 420, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a LAN, WAN, or the Internet. These elements may be in communication with one another via a data bus 428. In some embodiments, via an operating system 425 such as one supporting a web browser 423 and applications 422, the processor 424 may be configured to execute steps of a process establishing a communication channel and processing according to the embodiments described above.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A standing lumbar back distractor comprising:
a base;
a shaft comprising a lower end connected to the base and an upper end distal from the lower end;
an elbow support mechanism connected to the upper end of the shaft; and
a pelvic support mechanism disposed between the elbow support mechanism and the base.

2. The standing lumbar back distractor of claim 1, wherein the elbow support mechanism comprises:
a T-bar, the T-bar connected to the upper end of the shaft; and
a pair of elbow supports, wherein each elbow support is disposed at a corresponding end of the T-bar.

3. The standing lumbar back distractor of claim 2, wherein each elbow support comprises:
an upper portion;
an end portion; and
a curved portion connected between the upper portion and the end portion.

4. The standing lumbar back distractor of claim 3, wherein the upper portion and the curved portion define a first channel.

5. The standing lumbar back distractor of claim 3, wherein the end portion defines a second channel.

6. The standing lumbar back distractor of claim 3, wherein each elbow support further comprises:
a cushioning mechanism.

7. The standing lumbar back distractor of claim 3, wherein the upper portion extends past the stand.

8. The standing lumbar back distractor of claim 2, wherein the elbow supports are positioned at shoulder-length apart.

9. The standing lumbar back distractor of claim 1, wherein the pelvic support mechanism further comprises:
a pelvic support; and
an arm comprising a lower end connected to the shaft and an upper end attached to the pelvic support.

10. The standing lumbar back distractor of claim 9, wherein the pelvic support is rotatably attached to the arm.

11. The standing lumbar back distractor of claim 9, wherein the pelvic support comprises:
a roller element.

12. The standing lumbar back distractor of claim 9, wherein the pelvic support comprises:
a foam layer.

13. The standing lumbar back distractor of claim 9, wherein the pelvic support comprises:
a front face; and
a rear face opposite of the front face.

14. The standing lumbar back distractor of claim 13, wherein the front face has a concave shape.

15. The standing lumbar back distractor of claim 1, wherein the elbow support mechanism is slidably connected to the upper end of the shaft.

16. The standing lumbar back distractor of claim 1, wherein the base has a weighted portion.

17. The standing lumbar back distractor of claim 1, wherein the pelvis support mechanism is remotely controlled.

18. The standing lumbar back distractor of claim 1, wherein the elbow support mechanism is remotely controlled.

19. The standing lumbar back distractor of claim 1, wherein the base comprises:
a scale.

20. A method comprising:
placing one or more elbows in an elbow support mechanism of a standing lumbar back distractor, wherein the elbow support mechanism is connected to an upper end of a shaft, wherein the shaft comprises a lower end and the upper end, wherein the upper end of the shaft is distal from the lower end of the shaft, and wherein the lower end of the shaft is connected to a base; and
pressing a pelvis against a pelvic support mechanism of the standing lumbar back distractor, wherein the pelvic support mechanism is disposed between the elbow support mechanism and the base.
